(19) United States
(12) Patent Application Publication
(10) Pub. No.: US 2025/0272764 A1
(43) Pub. Date: Aug. 28, 2025

(54) STORAGE MEDIUM STORING AN APPLICATION PROGRAM, CONTROL METHOD FOR INFORMATION PROCESSING APPARATUS, AND INFORMATION PROCESSING APPARATUS

(71) Applicant: CANON KABUSHIKI KAISHA, Tokyo (JP)

(72) Inventor: Hiroya YAMAMOTO, Ibaraki (JP)

(21) Appl. No.: 19/055,597

(22) Filed: Feb. 18, 2025

(30) Foreign Application Priority Data
Feb. 22, 2024 (JP) 2024-025433

(51) Int. Cl. G06Q 50/00; G06T 11/60

(52) U.S. Cl. CPC G06Q 50/01; G06T 11/60

(57) ABSTRACT

A non-transitory computer-readable storage medium stores an application program for using a service that publishes post information for causing an information processing apparatus comprising the application program to execute a determining step of determining whether or not an image included in accepted post information is an image generated by a generative AI, and a restricting step of, in a case of being determined that the image included in the accepted post information is an image generated by the generative AI, restricting posting of the accepted post information.

### BACKGROUND OF THE INVENTION

### Field of the Invention

The present invention relates to a storage medium that stores an application program, a control method for an information processing apparatus, and an information processing apparatus.

### Description of the Related Art

In recent years, image generation technology using artificial intelligence (AI) has become widespread, and even individuals are able to easily generate images by using generative AI. This makes it possible for anyone to easily generate realistic images, but on the other hand, there have been occasional cases of malicious users using the generative AI to generate fabricated images of fictitious incidents or fictitious accidents, which has become a problem.

Incidentally, the use of social networking services (SNS), which allow users to post messages and images and interact with each other via the Internet, is increasing. As the use of the SNS increases, there is a problem of inappropriate content being posted. In order to deal with such a problem, techniques have been proposed for analyzing post information and detecting post information that includes inappropriate content. For example, in a technique disclosed in Japanese Laid-Open Patent Publication (kokai) No. 2022-39764, feature quantities are extracted from character string(s), image(s), and audio that are included in post information, and compared with information in a database to determine whether or not the post information includes inappropriate content.

However, with the technique disclosed in Japanese Laid-Open Patent Publication (kokai) No. 2022-39764, even in the case that the image included in the post information is a fabricated image generated by generative AI, if the image included in the post information is an image including information that could actually occur, the image included in the post information may not be determined to be inappropriate. In such a case, there is a concern that the post information including an AI-generated image that has fabricated a fictitious incident or accident has been made public, causing viewers to misidentify the post information.

### SUMMARY OF THE INVENTION

The present invention provides a storage medium that stores an application program, a control method for an information processing apparatus, and an information processing apparatus.

Accordingly, the present invention provides a non-transitory computer-readable storage medium storing an application program for using a service that publishes post information for causing an information processing apparatus comprising the application program to execute a determining step of determining whether or not an image included in accepted post information is an image generated by a generative AI, and a restricting step of, in a case of being determined that the image included in the accepted post information is an image generated by the generative AI, restricting posting of the accepted post information.

Accordingly, the present invention provides a non-transitory computer-readable storage medium storing an application program for using a service that publishes post information for causing an information processing apparatus comprising the application program to execute a determining step of determining whether or not an image included in accepted post information is an image generated by a generative AI, and a step of, in a case of being determined that the image included in the accepted post information is an image generated by the generative AI, performing a modification processing for preventing misidentification of viewers on the accepted post information.

Further features of the present invention will become apparent from the following description of exemplary embodiments with reference to the attached drawings.

### BRIEF DESCRIPTION OF THE DRAWINGS

FIG. 1 is a block diagram that schematically shows a configuration of a communication system that includes a communication apparatus as an information processing apparatus according to an embodiment of the present invention.

FIG. 2 is a block diagram that schematically shows a configuration of an AI image generation server shown in FIG. 1.

FIG. 3 is a block diagram that schematically shows a configuration of the communication apparatus shown in FIG. 1.

FIG. 4 is a block diagram that schematically shows a configuration of an SNS server shown in FIG. 1.

FIG. 5A and FIG. 5B are flowcharts that show the steps of an image generation processing by a generative AI in the communication system shown in FIG. 1.

FIG. 6A and FIG. 6B are flowcharts that show the steps of a first posting control processing executed by the communication system shown in FIG. 1.

FIGS. 7A, 7B and 7C are diagrams that show examples of screens displayed on a user I/F unit shown in FIG. 3.

FIG. 8A and FIG. 8B are flowcharts that show the steps of a second posting control processing executed by the communication system shown in FIG. 1.

FIG. 9A and FIG. 9B are diagrams for explaining a composite image generated by the process of S814 in FIG. 8B.

FIG. 10A and FIG. 10B are flowcharts that show the steps of a third posting control processing executed by the communication system shown in FIG. 1.

FIG. 11 is a diagram that shows an example of post information modified by the process of S1014 in FIG. 10B.

FIG. 12A and FIG. 12B are flowcharts that show the steps of a fourth posting control processing executed by the communication system shown in FIG. 1.

FIG. 13 is a diagram that shows an example of post information modified by the process of S1214 in FIG. 12B.

FIG. 14A and FIG. 14B are flowcharts that show the steps of a fifth posting control processing executed by the communication system shown in FIG. 1.

FIG. 15 is a flowchart that shows the procedure of a post information transmission processing executed by the communication apparatus shown in FIG. 1.

FIG. 16 is a flowchart that shows another procedure of the post information transmission processing executed by the communication apparatus shown in FIG. 1.

### DESCRIPTION OF THE EMBODIMENTS

The present invention will now be described in detail below with reference to the accompanying drawings showing embodiments thereof.

Hereinafter, an embodiment of the present invention will be described in detail with reference to the accompanying drawings. It should be noted that the following embodiment does not limit the present invention as defined by the claims, and not all of the combinations of features described in the present embodiment are necessarily essential to the solving means of the present invention.

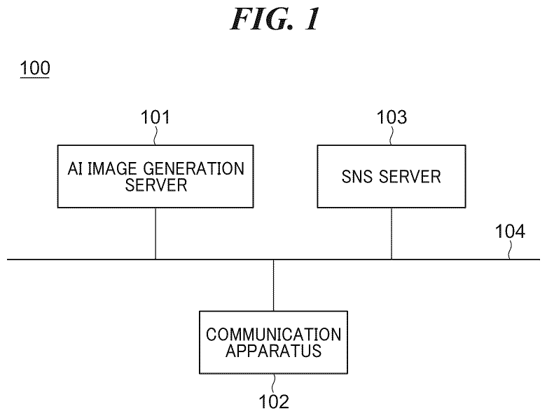

FIG. 1 is a block diagram that schematically shows a configuration of a communication system 100 that includes a communication apparatus 102 as an information processing apparatus according to the embodiment of the present invention.

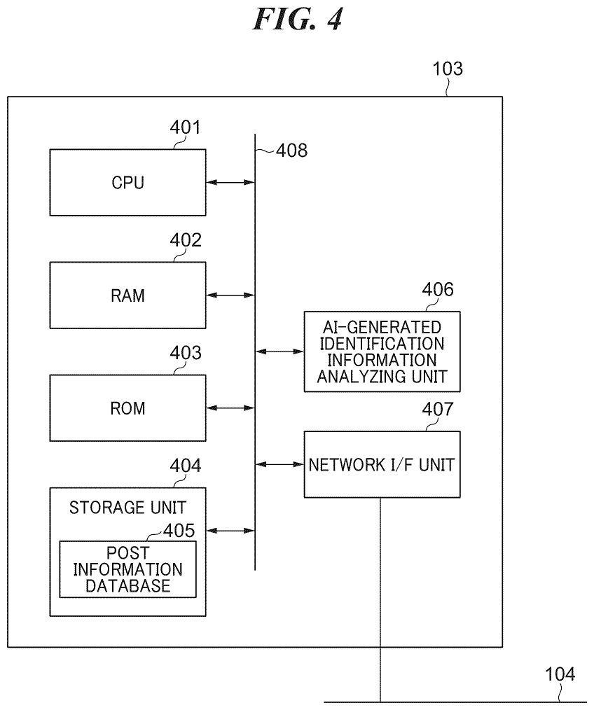

As shown in FIG. 1, the communication system 100 includes an AI image generation server 101, the communication apparatus 102, and an SNS server 103. The AI image generation server 101, the communication apparatus 102, and the SNS server 103 are able to communicate with each other via a network 104. In the communication system 100, the communication apparatus 102 makes a generation request to generate an image according to an instruction received from a user. The AI image generation server 101 generates an image (hereinafter, referred to as “an AI-generated image”) by using a generative AI in accordance with the generation request received from the communication apparatus 102, and transmits the generated AI-generated image to the communication apparatus 102. The user operates the communication apparatus 102 to create post information. This post information includes, for example, the AI-generated image that has been generated by the AI image generation server 101. The communication apparatus 102 transmits, to the SNS server 103, the post information that has been created by the user. The SNS server 103 is a server that provides an SNS service for publishing post information. The SNS server 103 registers the received post information in a post information database 405 shown in FIG. 4, which will be described below. As a result, a plurality of users who use the SNS service are able to view this post information.

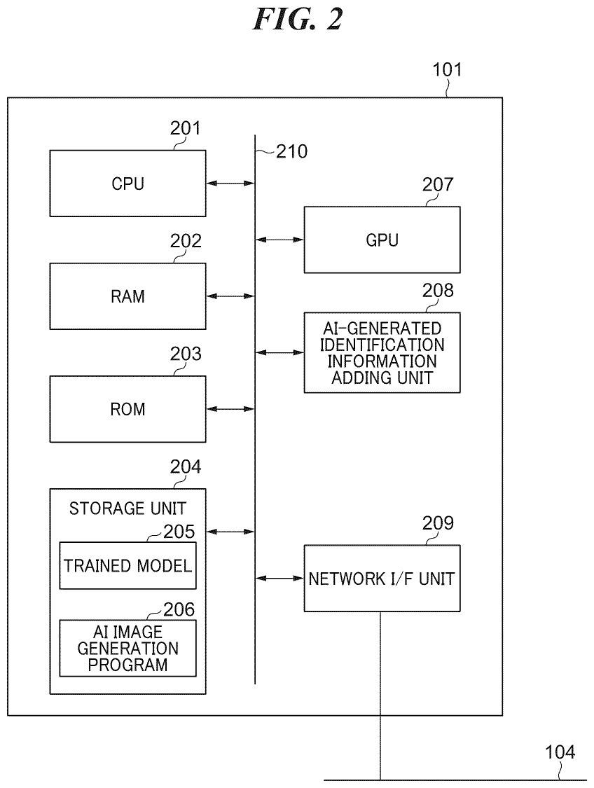

FIG. 2 is a block diagram that schematically shows a configuration of the AI image generation server 101 shown in FIG. 1. As shown in FIG. 2, the AI image generation server 101 includes a central processing unit (a CPU) 201, a random access memory (a RAM) 202, a read only memory (a ROM) 203, a storage unit 204, a graphics processing unit (a GPU) 207, an AI-generated identification information adding unit 208, and a network interface unit (a network I/F unit) 209. The CPU 201, the RAM 202, the ROM 203, the storage unit 204, the GPU 207, the AI-generated identification information adding unit 208, and the network I/F unit 209 are connected to each other via a bus 210.

The CPU 201 controls the operations of the AI image generation server 101 and runs based on a program that has been stored in the RAM 202. The ROM 203 is a boot ROM, and stores a boot program and the like of the system. The storage unit 204 is a nonvolatile device such as a hard disk drive (an HDD) or a solid state drive (an SSD), and stores a trained model 205 and an AI image generation program 206 that are used to realize the generative AI. It should be noted that, as an image generation means of the AI image generation server 101, a configuration will be described in which an arbitrary trained model 205 and an existing AI image generation program 206 such as Stable Diffusion are applied, but other image generation means may also be used. The trained model 205 and the AI image generation program 206 are loaded into the RAM 202 and are executed by the CPU 201. In the AI image generation server 101, when a generation request is received from the communication apparatus 102 or the like, the GPU 207 executes an AI image generation processing that generates an AI-generated image in accordance with instructions from the CPU 201.

The AI-generated identification information adding unit 208 adds, to the AI-generated image that has been generated by the AI image generation processing, AI-generated identification information for identifying that it is an image generated by the generative AI. This AI-generated identification information includes information indicating that it is an image generated by the generative AI, information regarding the trained model 205 and the AI image generation program 206 that have been used, information included in the generation request, etc. It should be noted that the format of the AI-generated identification information may be metadata such as header information of an image file, or the AI-generated identification information may be superimposed on the image itself as an invisible digital watermark or a visible text. The AI-generated image, to which the AI-generated identification information has been added, is transmitted to the communication apparatus 102 via the network 104 or is stored in the storage unit 204.

The network I/F unit 209 is connected to the network 104, and performs inputting and outputting various types of information via the network 104.

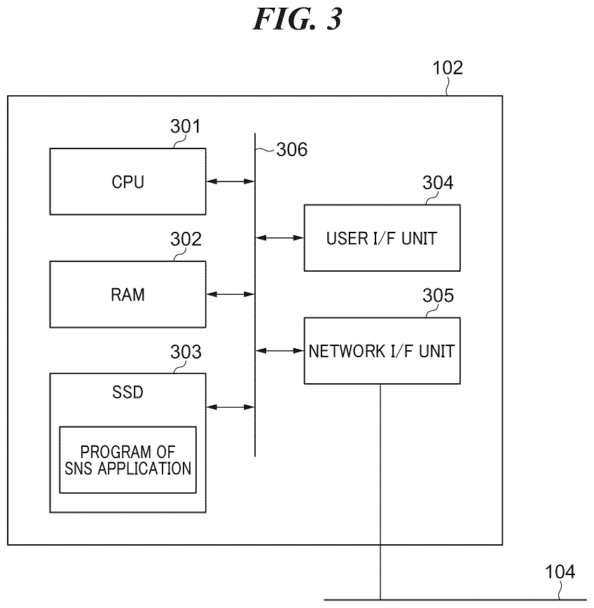

FIG. 3 is a block diagram that schematically shows a configuration of the communication apparatus 102 shown in FIG. 1. The communication apparatus 102 is an apparatus capable of communicating with the AI image generation server 101 and the SNS server 103, such as a smartphone, a tablet terminal, a personal computer (a PC), or the like.

As shown in FIG. 3, the communication apparatus 102 includes a CPU 301, a RAM 302, an SSD 303, a user I/F unit 304, and a network I/F unit 305. The CPU 301, the RAM 302, the SSD 303, the user I/F unit 304, and the network I/F unit 305 are connected to each other via a bus 306.

The CPU 301 controls the operations of the communication apparatus 102 and runs based on a program that has been loaded into the RAM 302. The SSD 303 stores system programs and the like. In addition, the SSD 303 stores a program for an SNS application (a program of an SNS application). The SNS application is an application for using the SNS service provided by the SNS server 103. The user I/F unit 304 includes a display, a touch panel, a keyboard, a mouse, etc., and performs input/output processing with the user. The network I/F unit 305 may be configured to be able to perform wired communication, or may be configured to be able to perform wireless communication. It should be noted that in the present embodiment, the communication apparatus 102 may include, in addition to the components shown in FIG. 3, a speech unit for implementing a telephone function, a photographing unit for implementing a camera function, and the like.

FIG. 4 is a block diagram that schematically shows a configuration of the SNS server 103 shown in FIG. 1. As shown in FIG. 4, the SNS server 103 includes a CPU 401, a RAM 402, a ROM 403, a storage unit 404, an AI-generated identification information analyzing unit 406, and a network I/F unit 407. The CPU 401, the RAM 402, the ROM 403, the storage unit 404, the AI-generated identification information analyzing unit 406, and the network I/F unit 407 are connected to each other via a bus 408.

The CPU 401 controls the operations of the SNS server 103 and runs based on a program that has been stored in the RAM 402. The ROM 403 is a boot ROM, and stores a boot program and the like of the system. The storage unit 404 is a storage unit that uses a nonvolatile device, such as an SSD, an HDD, or an embedded multi-media card (an eMMC). The storage unit 404 stores the post information database 405 for managing the post information received from an apparatus such as the communication apparatus 102. The AI-generated identification information analyzing unit 406 analyzes the image to determine the presence or absence of the AI-generated identification information that has been added by the AI-generated identification information adding unit 208. The network I/F unit 407 is connected to the network 104, and performs inputting and outputting various types of information via the network 104.

Next, a processing of generating an image by the generative AI in the communication system 100 will be described.

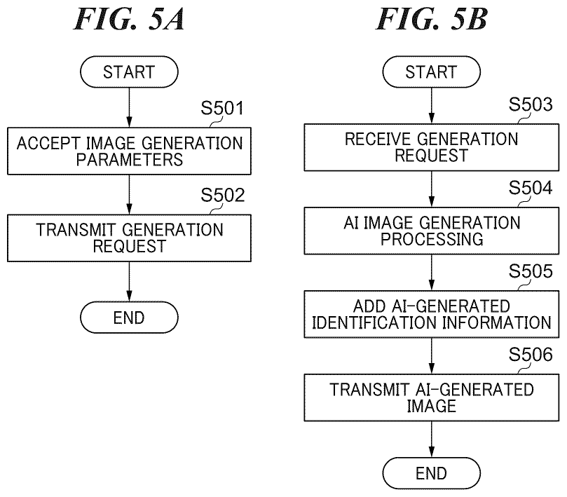

FIG. 5A and FIG. 5B are flowcharts that show the steps of an image generation processing by the generative AI in the communication system 100 shown in FIG. 1. This image generation processing is performed by the communication apparatus 102 and the AI image generation server 101.

FIG. 5A is a flowchart that shows the steps of a generation request transmission processing performed by the communication apparatus 102. The generation request transmission processing is realized by the CPU 301 of the communication apparatus 102 executing a program that has been stored in the SSD 303 or the like.

As shown in FIG. 5A, first, the CPU 301 accepts image generation parameters for generating an AI-generated image from the user (S501). The image generation parameters are those used in publically-known AI image generation technologies, such as keywords, sentences (prompts), images, etc. related to the image to be generated. Next, the CPU 301 generates a generation request to generate an AI-generated image based on the accepted image generation parameters, and transmits this generation request to the AI image generation server 101 (S502). After that, the generation request transmission processing ends.

FIG. 5B is a flowchart that shows the steps of an image generation control processing performed by the AI image generation server 101. The image generation control processing is realized by the CPU 201 of the AI image generation server 101 executing a program that has been stored in the ROM 203 or the storage unit 204.

As shown in FIG. 5B, when the CPU 201 receives the generation request from the communication apparatus 102 via the network 104 (S503), the CPU 201 controls the GPU 207 to perform the AI image generation processing (S504). As a result, an AI-generated image, which corresponds to the image generation parameters that have been inputted by the user, is generated. Next, the CPU 201 controls the AI-generated identification information adding unit 208 to add, to the AI-generated image that has been generated in S504, AI-generated identification information indicating that it is an image generated by the generative AI (S505). Next, the CPU 201 transmits the AI-generated image, to which the AI-generated identification information has been added, to the communication apparatus 102 via the network 104 (S506). After that, the image generation control processing ends.

Next, a processing related to posting of post information in the communication system 100 will be described.

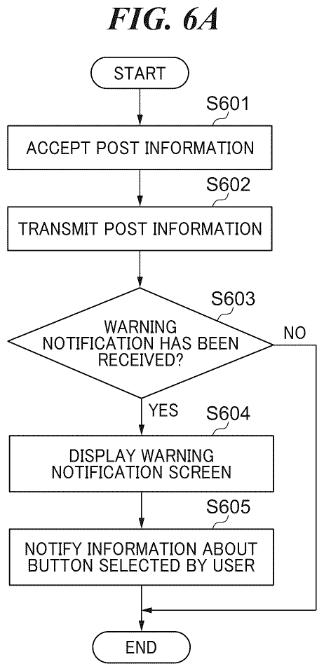

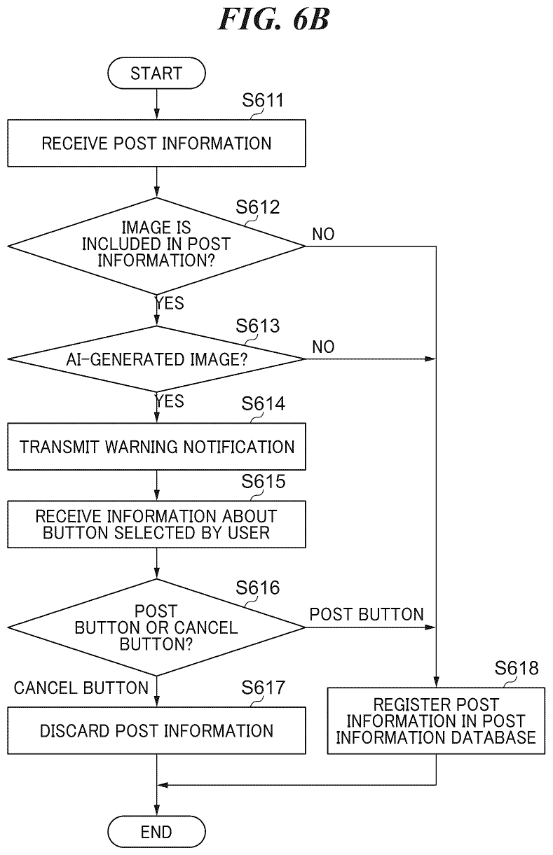

FIG. 6A and FIG. 6B are flowcharts that show the steps of a first posting control processing executed by the communication system 100 shown in FIG. 1. The first posting control processing is performed by the communication apparatus 102 and the SNS server 103.

FIG. 6A is a flowchart that shows the steps of a post information transmission processing performed by the communication apparatus 102. The post information transmission processing is realized by the CPU 301 of the communication apparatus 102 executing the program for the SNS application (the program of the SNS application) that has been stored in the SSD 303.

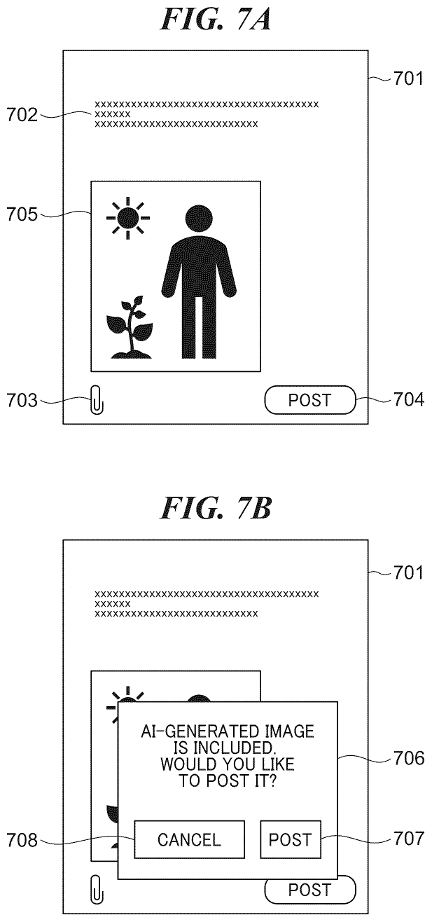

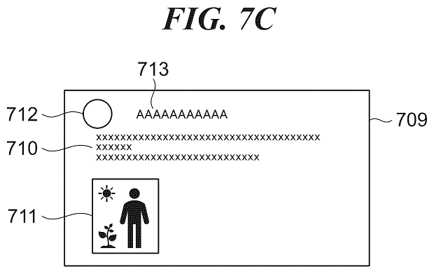

As shown in FIG. 6A, the CPU 301 accepts the post information from the user (S601). The post information includes at least any one of text data, audio data, image data, and moving image data (video data). In the present embodiment, the CPU 301 accepts the post information on a posting screen 701 that is shown in FIG. 7A and is displayed on the user I/F unit 304 (a display unit) of the communication apparatus 102. The posting screen 701 includes a character input section 702, a file selection section 703, and a post button 704. When the user selects one file by the file selection section 703, information about the selected file is displayed on the posting screen 701. As an example, in FIG. 7A, an image 705 that has been selected by the user in the file selection section 703 is displayed on the posting screen 701. When the user presses the post button 704, the CPU 301 accepts the post information.

Next, the CPU 301 transmits the accepted post information to the SNS server 103 (S602). The SNS server 103 performs a post information registration processing shown in FIG. 6B, which will be described below, and, for example, in the case that the received post information includes an AI-generated image, the

SNS server 103 transmits, to the communication apparatus 102, a warning notification indicating that the received post information includes an AI-generated image.

Next, the CPU 301 determines whether or not the warning notification has been received from the SNS server 103 (S603).

In the case of being determined in S603 that the warning notification has not been received from the SNS server 103, the post information transmission processing ends. On the other hand, in the case of being determined in S603 that the warning notification has been received from the SNS server 103, the CPU 301 performs a processing of restricting posting of the post information accepted in S601. Specifically, the CPU 301 causes a warning notification screen 706 of FIG. 7B to be displayed on the posting screen 701 displayed on the user I/F unit 304 (S604). The warning notification screen 706 is a screen for allowing the user (a poster) to select whether or not to post the post information accepted in S601 as is, and includes a post button 707 and a cancel button 708.

Next, the CPU 301 notifies the SNS server 103 of information about the button pressed by the user, either the post button 707 or the cancel button 708 (S605), and the post information transmission processing ends.

FIG. 6B is a flowchart that shows the steps of the post information registration processing performed by the SNS server 103. The post information registration processing is realized by the CPU 401 of the SNS server 103 executing a program that has been stored in the ROM 403 or the storage unit 404.

As shown in FIG. 6B, the CPU 401 receives the post information that has been transmitted from the communication apparatus 102 (S611). Next, the CPU 401 analyzes the received post information and determines whether or not this post information includes an image (S612).

In the case of being determined in S612 that this post information includes an image, the CPU 401 controls the AI-generated identification information analyzing unit 406 to determine whether or not the image included in the post information is an AI-generated image (S613). For example, in the case that AI-generated identification information has been added to the image included in the post information, it is determined that the image included in the post information is an AI-generated image. On the other hand, in the case that AI-generated identification information has not been added to the image included in the post information, it is determined that the image included in the post information is not an AI-generated image.

In the case of being determined in S613 that the image included in the post information is an AI-generated image, the CPU 401 transmits, to the communication apparatus 102, a warning notification indicating that the post information received in S611 includes an AI-generated image (S614). In the communication apparatus 102 that has received this warning notification, the warning notification screen 706 is displayed in S604 described above. Furthermore, in S605 described above, the information about the button pressed by the user, either the post button 707 or the cancel button 708 is notified to the SNS server 103.

When the CPU 401 receives the information about the button pressed by the user from the communication apparatus 102 (S615), the CPU 401 determines whether the button pressed by the user is the post button 707 or the cancel button 708 based on the received information (S616).

In the case of being determined in S616 that the button pressed by the user is the cancel button 708, the CPU 401 discards the post information received in S611 (S617). As a result, the post information received in S611 is not registered in the post information database 405, and this post information is not made public. After that, the post information registration processing ends.

In the case of being determined in S612 that this post information does not include an image, the post information registration processing proceeds to S618. In addition, in the case of being determined in S613 that the image included in the post information is not an AI-generated image, the post information registration processing proceeds to S618. Moreover, in the case of being determined in S616 that the button pressed by the user is the post button 707, the post information registration processing proceeds to S618.

In S618, the CPU 401 registers, in the post information database, the post information received in S611. As a result, this post information is made public, and the poster and other users who use the SNS service are able to view the registered post information, for example, post information 709 shown in FIG. 7C. A message display section 710 of the post information 709 displays the character string that has been inputted by the poster in the character input section 702, and a file display section 711 displays the image that has been selected by the poster in the file selection section 703. In addition, the post information 709 may include an icon display section 712 in which the poster's icon is displayed, and a user name display section 713 in which the poster's name is displayed. When the process of S618 is completed, the post information registration processing ends.

According to the embodiment described above, in the case of being determined that the image included in the post information accepted in S601 is an AI-generated image, the processing of restricting posting of this post information is performed. As a result, it is possible to suppress posting of AI-generated images that cause viewers to misidentify.

In addition, in the embodiment described above, the user I/F unit 304 displays the warning notification screen 706 that allows the poster to select whether or not to post the post information accepted in S601. In other words, in the case that the post information accepted in S601 includes an AI-generated image, the poster is given an opportunity to reconsider whether or not to post this post information. As a result, it is possible to suppress posting of AI-generated images that unintentionally cause viewers to misidentify, which is performed by the poster.

In addition, in the embodiment described above, the determination of whether or not the image included in the post information is an AI-generated image is made based on whether or not the AI-generated identification information has been added to the image included in the accepted post information. As a result, in the configuration in which the AI image generation server 101 includes the AI-generated identification information adding unit 208, it is possible to easily determine whether or not the image included in the post information is an AI-generated image.

Although the present invention has been described by using the embodiment described above, the present invention is not limited to the embodiment described above. For example, the post information may include a plurality of images. In the case that a plurality of images are included in the post information, it may be notified as to which images are AI-generated images.

It should be noted that among AI-generated images, photographs are more likely to cause to give misidentification of fictitious incidents or fictitious accidents, but illustrations are less likely to cause to give misidentification of fictitious incidents or fictitious accidents. Therefore, in the case that the AI-generated image is an illustration in S613 described above, posting of post information including such an AI-generated image may not be restricted, and the post information registration processing may proceed to S618.

In addition, in the embodiment described above, the configuration, in which the determination of S613 is made based on the presence or absence of the AI-generated identification information, has been described, but the present invention is not limited to this configuration. For example, in the determination of S613, an AI may be used that inputs the image included in the post information and outputs a determination result indicating whether or not the image included in the post information is an AI-generated image. It should be noted that the SNS server 103 may include a trained model for realizing this AI. Alternatively, a configuration, in which the SNS server 103 transmits the image included in the post information to an AI server including a trained model for realizing this AI and obtains a determination result from this AI server, may be adopted. By using such an AI, even in the case that the AI image generation server 101 does not include the AI-generated identification information adding unit 208, it is possible to easily determine whether or not the image included in the post information is an AI-generated image.

In addition, in the present embodiment, the determination of S613 may be made based on predetermined information included in the AI-generated identification information. The predetermined information is, for example, a probability or a score indicating the likelihood of an AI-generated image. For example, in S613, the CPU 401 converts the likelihood of an AI-generated image into a percentage, and in the case that the likelihood of a certain part being an AI-generated image is equal to or greater than a threshold value N %, it is determined that the image included in the post information is an AI-generated image. On the other hand, in the case that the likelihood of a certain part being an AI-generated image is less than the threshold value N %, it is determined that the image included in the post information is not an AI-generated image. It should be noted that the threshold value N % may be stored in advance in the storage unit 404 or may be included in the post information. By using such a probability or a score indicating the likelihood of an AI-generated image, it is possible to determine whether or not the image included in the post information is an AI-generated image.

In addition, in the embodiment described above, the configuration, in which as the processing of restricting posting of the post information accepted in S601, the processing of displaying the warning notification screen 706, which allows the user to select whether or not to post this post information as is, is performed, has been described, but the present invention is not limited to this configuration. For example, as the processing of restricting posting of the post information accepted in S601, another warning notification screen for instructing prohibition of posting of this post information may be displayed on the user I/F unit 304. The another warning notification screen includes a message indicating that this post information cannot be posted because this post information includes an AI-generated image, and the cancel button 708, and does not include the post button 707. As a result, it is possible to reliably prevent posting of AI-generated images that cause viewers to misidentify.

In addition, in the embodiment described above, the configuration, in which in the case that the image included in the post information is an AI-generated image, the post information is restricted, has been described, but the present invention is not limited to this configuration. For example, in the case that the image included in the post information is an AI-generated image, a modification processing for preventing misidentification of viewers may be performed with respect to this post information.

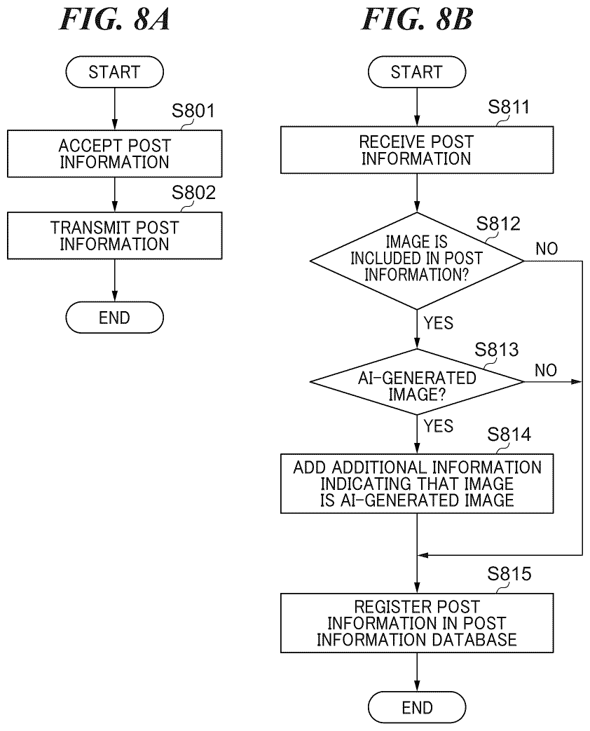

FIG. 8A and FIG. 8B are flowcharts that show the steps of a second posting control processing executed by the communication system 100 shown in FIG. 1. It should be noted that the second posting control processing is similar to the first posting control processing described above, and the following will particularly describe the differences from the first posting control processing described above. Similar to the first posting control processing described above, the second posting control processing is also performed by the communication apparatus 102 and the SNS server 103.

FIG. 8A is a flowchart that shows the steps of a post information transmission processing performed by the communication apparatus 102. Similar to the post information transmission processing of FIG. 6A described above, the post information transmission processing of FIG. 8A is also realized by the CPU 301 of the communication apparatus 102 executing the program for the SNS application that has been stored in the SSD 303.

As shown in FIG. 8A, S801 and S802, which are the same processes as S601 and S602 that have been described above, are performed, and the post information transmission processing of FIG. 8A ends.

FIG. 8B is a flowchart that shows the steps of a post information registration processing performed by the SNS server 103. Similar to the post information registration processing of FIG. 6B described above, the post information registration processing of FIG. 8B is also realized by the CPU 401 of the SNS server 103 executing a program that has been stored in the ROM 403 or the storage unit 404.

As shown in FIG. 8B, S811, S812, and S813, which are the same processes as S611, S612, and S613 that have been described above, are performed.

In the case of being determined in S812 that this post information does not include an image, or in the case of being determined in S813 that the image included in the post information is not an AI-generated image, the post information registration processing of FIG. 8B proceeds to S815, which is the same process as S618 described above. After that, the post information registration processing of FIG. 8B ends.

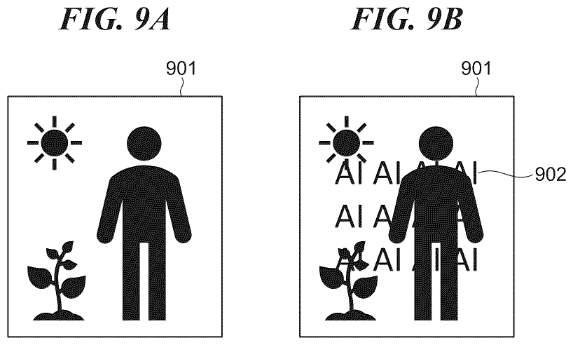

In the case of being determined in S813 that the image included in the post information is an AI-generated image, the CPU 401 performs a modification processing for preventing misidentification of viewers on this post information. Specifically, the CPU 401 adds, to an image determined to be an AI-generated image in this post information, additional information indicating that this image is an AI-generated image (S814). Here, the process of S814 will be described in detail. An image 901 shown in FIG. 9A is an example of an AI-generated image before performing the process of S814. In S814, as shown in FIG. 9B, the CPU 401 composites additional information 902 indicating that the image 901 is an AI-generated image with the image 901. It should be noted that in FIG. 9B, an example is shown in which a character string “AI” has been added as the additional information 902, but another character string or an image may be added as the additional information as long as another character string or an image is information that allows the viewer to recognize that the image is an AI-generated image. Next, the post information registration processing of FIG. 8B proceeds to S815, which is the same process as S618 described above.

In the embodiment described above, in the case of being determined that the image included in the accepted post information is an AI-generated image, the modification processing for preventing misidentification of viewers is performed with respect to the accepted post information. In other words, in the case that the accepted post information includes an AI-generated image, the accepted post information will not be posted at least in a state that could cause viewers to misidentify. As a result, it is possible to suppress posting of AI-generated images that cause viewers to misidentify.

In addition, in the embodiment described above, in the modification processing, the image 901 included in the accepted post information is composited with the additional information 902 indicating that the image 901 is an AI-generated image. As a result, it is possible to make a viewer who has viewed the post information including the image 901, with which the additional information 902 has been composited, aware that there is a concern that this post information includes information that is different from the facts, thereby preventing the viewer from misidentifying.

It should be noted that in the present embodiment, as the modification processing for preventing misidentification of viewers, a processing, in which the additional information indicating that this image is an AI-generated image is added as property information of the image included in the accepted post information, may be performed. As a result, without editing the AI-generated image included in the post information, it is possible to make the viewer aware that there is a concern that this post information includes information that is different from the facts.

In addition, in the present embodiment, as the modification processing for preventing misidentification of viewers, a processing, in which a message, which indicates that an AI-generated image is included, is added to the accepted post information, may be performed.

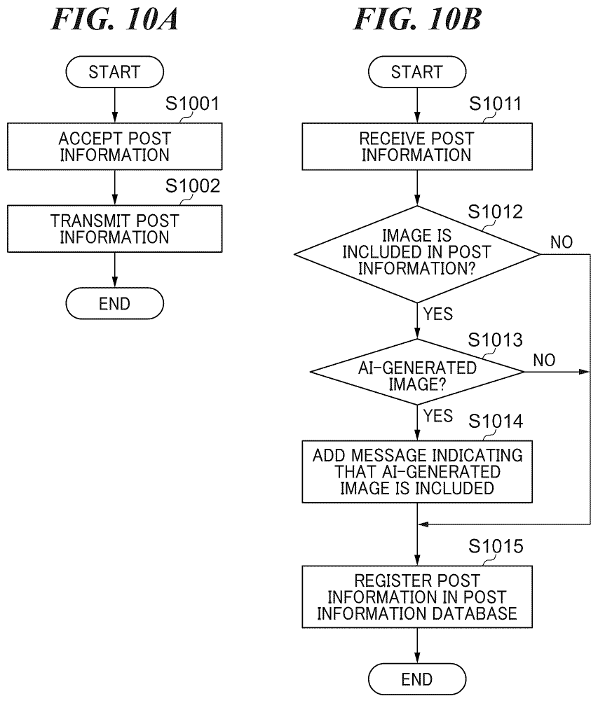

FIG. 10A and FIG. 10B are flowcharts that show the steps of a third posting control processing executed by the communication system 100 shown in FIG. 1. It should be noted that the third posting control processing is similar to the first posting control processing and the second posting control processing that have been described above, and the following will particularly describe the differences from the first posting control processing and the second posting control processing that have been described above. Similar to the first posting control processing and the second posting control processing that have been described above, the third posting control processing is also performed by the communication apparatus 102 and the SNS server 103.

FIG. 10A is a flowchart that shows the steps of a post information transmission processing performed by the communication apparatus 102. Similar to the post information transmission processing of FIG. 6A and the post information transmission processing of FIG. 8A that have been described above, the post information transmission processing of FIG. 10A is also realized by the CPU 301 of the communication apparatus 102 executing the program for the SNS application that has been stored in the SSD 303.

As shown in FIG. 10A, S1001 and S1002, which are the same processes as S601 and S602 that have been described above, are performed, and the post information transmission processing of FIG. 10A ends.

FIG. 10B is a flowchart that shows the steps of a post information registration processing performed by the SNS server 103. Similar to the post information registration processing of FIG. 6B and the post information registration processing of FIG. 8B that have been described above, the post information registration processing of FIG. 10B is also realized by the CPU 401 of the SNS server 103 executing a program that has been stored in the ROM 403 or the storage unit 404.

As shown in FIG. 10B, S1011, S1012, and S1013, which are the same processes as S611, S612, and S613 that have been described above, are performed.

In the case of being determined in S1012 that this post information does not include an image, or in the case of being determined in S1013 that the image included in the post information is not an AI-generated image, the post information registration processing of FIG. 10B proceeds to S1015, which is the same process as S618 described above. After that, the post information registration processing of FIG. 10B ends.

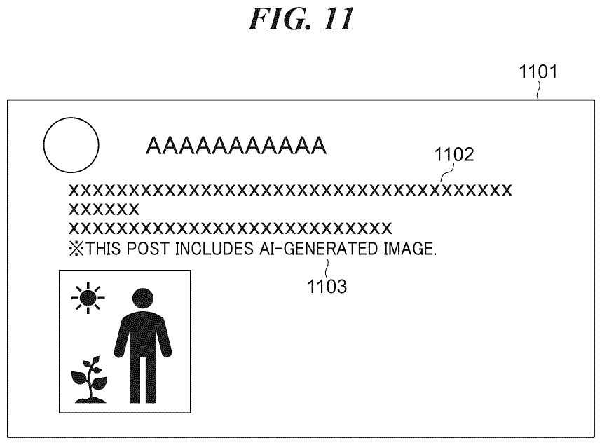

In the case of being determined in S1013 that the image included in the post information is an AI-generated image, the CPU 401 performs a modification processing for preventing misidentification of viewers on this post information. Specifically, the CPU 401 adds, to this post information, a message indicating that an AI-generated image is included (S1014). Next, the post information registration processing of FIG. 10B proceeds to S1015, which is the same process as S618 described above. For example, in S1015, when the post information, to which the message has been added, is registered in the post information database 405, the poster and other users who use the SNS service are able to view the registered post information, for example, post information 1101 shown in FIG. 11. In addition to a character string 1102 inputted by the poster, the post information 1101 also includes a message 1103 indicating that an AI-generated image is included. When the process of S1015 is completed, the post information registration processing of FIG. 10B ends.

In the embodiment described above, as the modification processing for preventing misidentification of viewers, the processing, in which the message, which indicates that an AI-generated image is included, is added to the accepted post information, is performed. As a result, without editing the AI-generated image included in the post information, it is possible to make the viewer aware at a glance that there is a concern that this post information includes information that is different from the facts.

It should be noted that in the present embodiment, as the modification processing for preventing misidentification of viewers, a processing of excluding the AI-generated image from the post information may be performed.

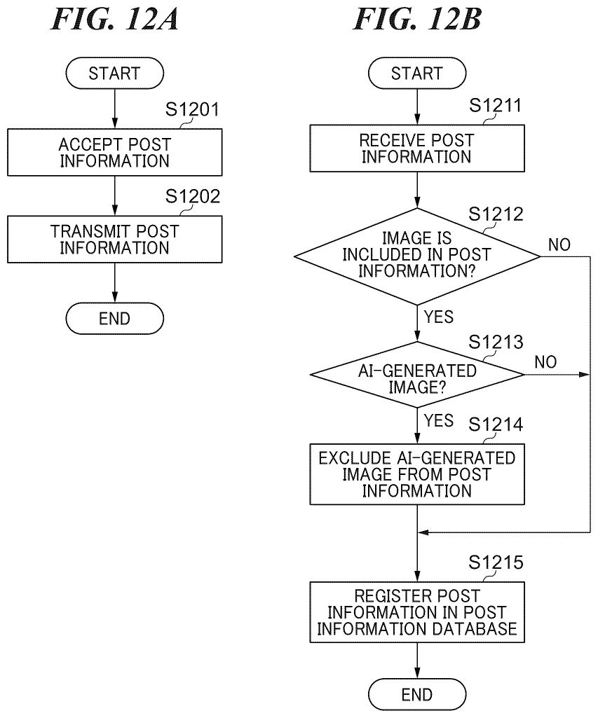

FIG. 12A and FIG. 12B are flowcharts that show the steps of a fourth posting control processing executed by the communication system 100 shown in FIG. 1. It should be noted that the fourth posting control processing is similar to the first posting control processing, the second posting control processing, and the third posting control processing that have been described above, and the following will particularly describe the differences from the first posting control processing, the second posting control processing, and the third posting control processing that have been described above. Similar to the first posting control processing, the second posting control processing, and the third posting control processing that have been described above, the fourth posting control processing is also performed by the communication apparatus 102 and the SNS server 103.

FIG. 12A is a flowchart that shows the steps of a post information transmission processing performed by the communication apparatus 102. Similar to the post information transmission processing of FIG. 6A, the post information transmission processing of FIG. 8A, and the post information transmission processing of FIG. 10A that have been described above, the post information transmission processing of FIG. 12A is also realized by the CPU 301 of the communication apparatus 102 executing the program for the SNS application that has been stored in the SSD 303.

As shown in FIG. 12A, S1201 and S1202, which are the same processes as S601 and S602 that have been described above, are performed, and the post information transmission processing of FIG. 12A ends.

FIG. 12B is a flowchart that shows the steps of a post information registration processing performed by the SNS server 103. Similar to the post information registration processing of FIG. 6B, the post information registration processing of FIG. 8B, and the post information registration processing of FIG. 10B that have been described above, the post information registration processing of FIG. 12B is also realized by the CPU 401 of the SNS server 103 executing a program that has been stored in the ROM 403 or the storage unit 404.

As shown in FIG. 12B, S1211, S1212, and S1213, which are the same processes as S611, S612, and S613 that have been described above, are performed.

In the case of being determined in S1212 that this post information does not include an image, or in the case of being determined in S1213 that the image included in the post information is not an AI-generated image, the post information registration processing of FIG. 12B proceeds to S1215, which is the same process as S618 described above. After that, the post information registration processing of FIG. 12B ends.

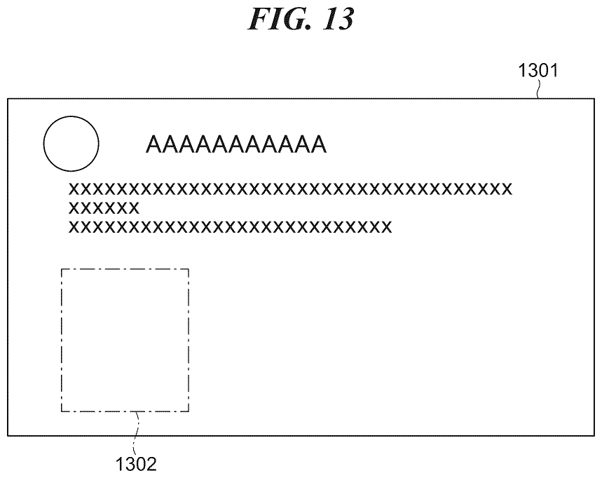

In the case of being determined in S1213 that the image included in the post information is an AI-generated image, the CPU 401 performs a modification processing for preventing misidentification of viewers on this post information. Specifically, the CPU 401 excludes the AI-generated image from this post information (S1214). It should be noted that in the case that this post information includes a plurality of images, only AI-generated images among the plurality of images will be excluded. Next, the post information registration processing of FIG. 12B proceeds to S1215, which is the same process as S618 described above. For example, in S1215, when the post information, from which the AI-generated image has been excluded, is registered in the post information database 405, the poster and other users who use the SNS service are able to view the registered post information, for example, post information 1301 shown in FIG. 13. In the post information 1301, the placement area of the excluded AI-generated image is displayed as blank, which is shown by a reference sign 1302. When the process of S1215 is completed, the post information registration processing of FIG. 12B ends.

In the embodiment described above, as the modification processing for preventing misidentification of viewers, the processing of excluding the AI-generated image from the post information is performed. As a result, it is possible to reliably prevent misidentification of viewers that is caused by the AI-generated image.

It should be noted that in the present embodiment, in S1214, the post information may be subjected to a processing of filling in the area of the AI-generated image with a background color or another color other than the background color.

In addition, in the present embodiment, in the case that the image included in the post information is an AI-generated image, it may be possible to control whether or not to perform the modification processing on this post information based on information about the generation source of this image.

For example, image super-resolution or color conversion that uses AI generation technology generates an image based on an input image. Therefore, the generated image includes factual information, and even in the case that the post information including such a generated image is posted as is, it is unlikely to cause third parties to misidentify. On the other hand, among AI generation technologies, for example, Stable Diffusion generates images from character strings, and Deep Convolutional Generative Adversarial Networks (DCGAN) generate images from noises. There is a concern that an AI-generated image generated by the generative AI based on information other than images (non-image information) in this way is a fictitious image that is different from the facts, and when the post information including such an image is posted as is, there is a very high possibility of causing third parties to misidentify.

In order to deal with this issue, in the present embodiment, in the case that the image included in the post information is an AI-generated image, whether or not to perform the modification processing on this post information is controlled based on the information about the generation source (generation source information) of this image.

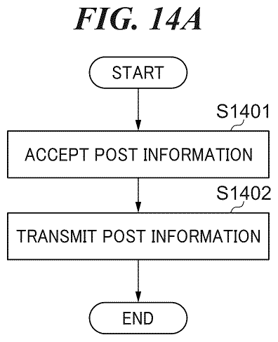

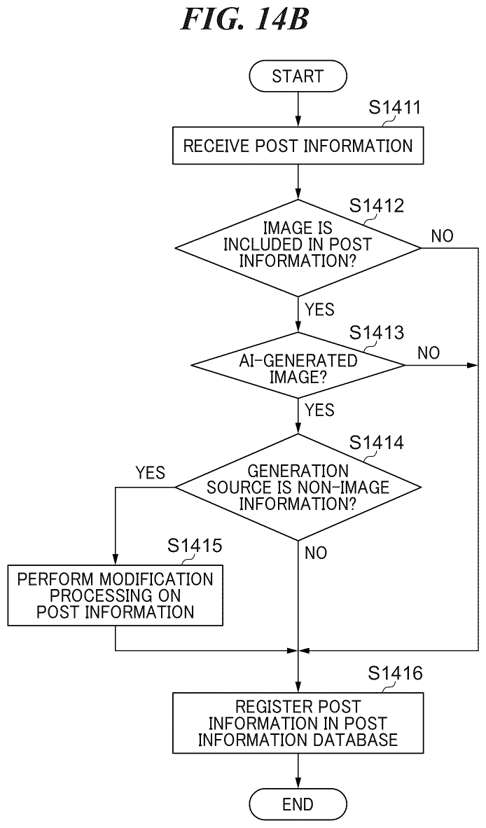

FIG. 14A and FIG. 14B are flowcharts that show the steps of a fifth posting control processing executed by the communication system 100 shown in FIG. 1. It should be noted that the fifth posting control processing is similar to the first posting control processing, the second posting control processing, the third posting control processing, and the fourth posting control processing that have been described above, and the following will particularly describe the differences from the first posting control processing, the second posting control processing, the third posting control processing, and the fourth posting control processing that have been described above. Similar to the first posting control processing, the second posting control processing, the third posting control processing, and the fourth posting control processing that have been described above, the fifth posting control processing is also performed by the communication apparatus 102 and the SNS server 103.

FIG. 14A is a flowchart that shows the steps of a post information transmission processing performed by the communication apparatus 102. Similar to the post information transmission processing of FIG. 6A, the post information transmission processing of FIG. 8A, the post information transmission processing of FIG. 10A, and the post information transmission processing of FIG. 12A that have been described above, the post information transmission processing of FIG. 14A is also realized by the CPU 301 of the communication apparatus 102 executing the program for the SNS application that has been stored in the SSD 303.

As shown in FIG. 14A, S1401 and S1402, which are the same processes as S601 and S602 that have been described above, are performed, and the post information transmission processing of FIG. 14A ends.

FIG. 14B is a flowchart that shows the steps of a post information registration processing performed by the SNS server 103. Similar to the post information registration processing of FIG. 6B, the post information registration processing of FIG. 8B, the post information registration processing of FIG. 10B, and the post information registration processing of FIG. 12B that have been described above, the post information registration processing of FIG. 14B is also realized by the CPU 401 of the SNS server 103 executing a program that has been stored in the ROM 403 or the storage unit 404.

As shown in FIG. 14B, S1411, S1412, and S1413, which are the same processes as S611, S612, and S613 that have been described above, are performed.

In the case of being determined in S1412 that this post information does not include an image, or in the case of being determined in S1413 that the image included in the post information is not an AI-generated image, the post information registration processing of FIG. 14B proceeds to S1416, which is the same process as S618 described above. After that, the post information registration processing of FIG. 14B ends.

In the case of being determined in S1413 that the image included in the post information is an AI-generated image, the CPU 401 determines whether or not the generation source of this image is the information other than images (the non-image information) based on the generation source information included in the AI-generated identification information of this image (S1414).

In the case of being determined in S1414 that the generation source of this image is not the information other than images (the non-image information), that is, in the case that the generation source of this image is an image, the post information registration processing of FIG. 14B proceeds to S1416. Here, in the case that the generation source of this image is an image, since this image is an image generated by the generative AI based on an input image, that is, this image is an image that includes factual information, even in the case that the post information including such an image is posted as is, it is unlikely to cause third parties to misidentify. Therefore, in S1416, the CPU 401 registers the post information received in S1411 in the post information database 405 as is. After that, the post information registration processing of FIG. 14B ends.

In the case of being determined in S1414 that the generation source of this image is the information other than images (the non-image information), the post information registration processing of FIG. 14B proceeds to S1415. Here, in the case that the generation source of this image is the information other than images (the non-image information), this image is an image generated by the generative AI based on the information other than images (the non-image information), such as character strings or noises. There is a concern that an AI-generated image generated by the generative AI based on information other than images (non-image information) in this way is a fabricated image of a fictitious incident or a fictitious accident that is different from the facts, and when the post information including such an image is posted as is, there is a very high possibility of causing third parties to misidentify. Therefore, in S1415, the CPU 401 performs a modification processing for preventing misidentification of viewers on the post information received in S1411. It should be noted that the modification processing is, for example, as described above, a processing of compositing additional information indicating that the image is an AI-generated image with the AI-generated image. In addition, the modification processing is a processing of adding additional information indicating that the image is an AI-generated image as property information of the AI-generated image. In addition, the modification processing is a processing of adding a message indicating that an AI-generated image is included. In addition, the modification processing is a processing of excluding the AI-generated image from the post information. Next, the post information registration processing of FIG. 14B proceeds to S1416.

In the embodiment described above, in the case of being determined that the image included in the accepted post information is an image generated by the generative AI using an input image as input, the modification processing for preventing misidentification of viewers will not be performed. On the other hand, in the case of being determined that the image included in the accepted post information is an image generated by the generative AI using information other than the input image as input, the modification processing for preventing misidentification of viewers will be performed. As a result, it is possible to perform the above-described modification processing on the AI-generated image that is likely to include information that is different from the facts, while preventing the modification processing from being excessively performed on the AI-generated image that does not require modification.

It should be noted that in the embodiment described above, the configuration, in which the SNS server 103 determines whether or not the image included in the post information is an AI-generated image, has been described, but the present invention is not limited to this configuration. For example, the communication apparatus 102 on which the SNS application has been installed may determine whether or not the image included in the post information is an AI-generated image.

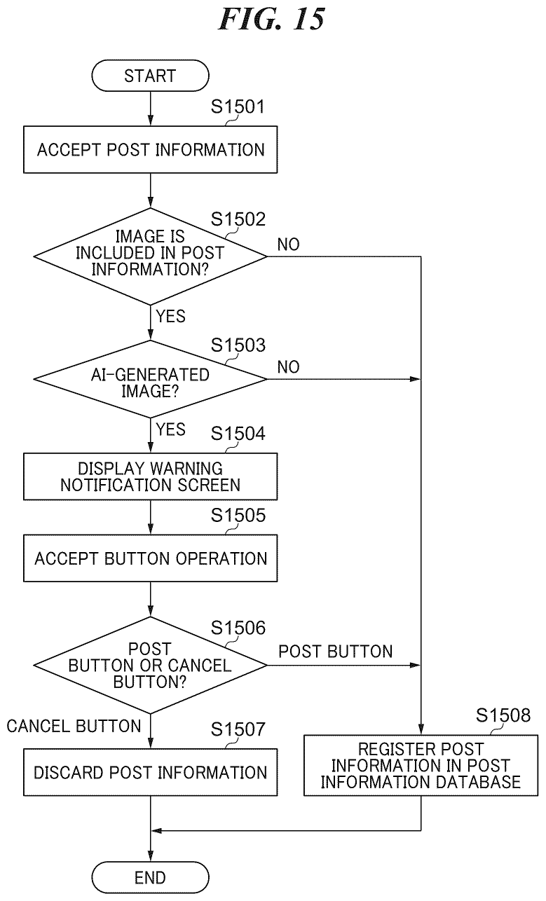

FIG. 15 is a flowchart that shows the procedure of a post information transmission processing executed by the communication apparatus 102 shown in FIG. 1. It should be noted that the post information transmission processing of FIG. 15 is similar to the first posting control processing described above, and the following will particularly describe the differences from the first posting control processing described above. Similar to the post information transmission processing of FIG. 6A described above, the post information transmission processing of FIG. 15 is also realized by the CPU 301 of the communication apparatus 102 executing the program for the SNS application that has been stored in the SSD 303.

As shown in FIG. 15, the CPU 301 performs S1501, which is the same process as S601 described above. Next, the CPU 301 analyzes the accepted post information and determines whether or not this post information includes an image (S1502).

In the case of being determined in S1502 that this post information includes an image, the CPU 401 determines whether or not the image included in the post information is an AI-generated image (S1503). It should be noted that in the present embodiment, as in S613 described above, the determination of S1503 may be made based on the presence or absence of the AI-generated identification information. In addition, the determination of S1503 may be made by using an AI that inputs the image included in the post information and outputs a determination result indicating whether or not the image included in the post information is an AI-generated image. It should be noted that in the present embodiment, the communication apparatus 102 may include a trained model for realizing this AI. Alternatively, a configuration, in which the communication apparatus 102 transmits the image included in the post information to an AI server including a trained model for realizing this AI and obtains a determination result from this AI server, may be adopted.

In the case of being determined in S1503 that the image included in the post information is an AI-generated image, the CPU 301 performs a processing of restricting posting of the post information accepted in S1501. Specifically, the CPU 301 causes the warning notification screen 706 to be displayed on the posting screen 701 displayed on the user I/F unit 304.

Next, the CPU 301 accepts a button operation such as pressing either the post button 707 or the cancel button 708 on the warning notification screen 706 by the user (S1505). Next, the CPU 301 determines whether the button pressed by the user is the post button 707 or the cancel button 708 (S1506).

In the case of being determined in S1506 that the button pressed by the user is the cancel button 708, the CPU 301 discards the post information accepted in S1501 (S1507). After that, the post information transmission processing of FIG. 15 ends.

In the case of being determined in S1502 that this post information does not include an image, the post information transmission processing of FIG. 15 proceeds to S1508. In addition, also in the case of being determined in S1503 that the image included in the post information is not an AI-generated image, the post information transmission processing of FIG. 15 proceeds to $1508. Furthermore, also in the case of being determined in S1506 that the button pressed by the user is the post button 707, the post information transmission processing of FIG. 15 proceeds to S1508.

In S1508, the CPU 301 registers, in the post information database, the post information accepted in S1501. After that, the post information transmission processing of FIG. 15 ends.

In the embodiment described above, in the communication apparatus 102 on which the SNS application has been installed, in the case of being determined that the image included in the accepted post information is an AI-generated image, the processing of restricting posting of this post information is performed. As a result, it is possible to suppress posting of AI-generated images that cause viewers to misidentify.

It should be noted that also in the above-described post information transmission processing of FIG. 15, similar to the above-described configuration, in the case that the image determined to be an AI-generated image in S1503 is an illustration, posting of the post information including this AI-generated image may not be restricted and the post information transmission processing of FIG. 15 may proceed to S1508.

In addition, also in the above-described post information transmission processing of FIG. 15, similar to the above-described configuration, the determination of S1503 may be made based on predetermined information included in the AI-generated identification information, for example, a probability or a score indicating the likelihood of an AI-generated image.

In addition, also in the above-described post information transmission processing of FIG. 15, similar to the above-described configuration, in the case that the image included in the post information is an AI-generated image, control to prohibit posting of this post information may be performed. Specifically, in S1504, another warning notification screen, which includes a message indicating that this post information cannot be posted because this post information includes an AI-generated image, and the cancel button 708, and does not include the post button 707, is displayed on the user I/F unit 304. When the user presses the cancel button 708, the post information accepted in S1501 is discarded (S1507). As a result, it is possible to reliably prevent posting of AI-generated images that cause viewers to misidentify.

In addition, in the present embodiment, in the case that the image included in the post information is an AI-generated image, the communication apparatus 102, on which the SNS application has been installed, may perform a modification processing for preventing misidentification of viewers with respect to this post information.

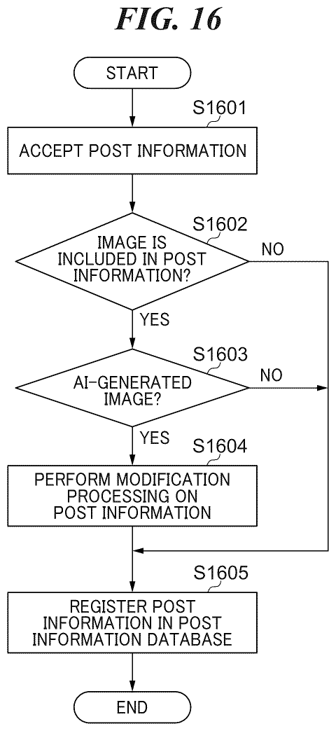

FIG. 16 is a flowchart that shows another procedure of the post information transmission processing executed by the communication apparatus 102 shown in FIG. 1. It should be noted that the post information transmission processing of FIG. 16 is similar to the post information transmission processing of FIG. 15 that has been described above, and the following will particularly describe the differences from the post information transmission processing of FIG. 15 that has been described above. Similar to the post information transmission processing of FIG. 15 that has been described above, the post information transmission processing of FIG. 16 is also realized by the CPU 301 of the communication apparatus 102 executing the program for the SNS application that has been stored in the SSD 303.

As shown in FIG. 16, the CPU 301 performs S1601, S1602, and S1603, which are the same processes as S1501, S1502, and S1503 that have been described above.

In the case of being determined in S1603 that the image included in the post information is an AI-generated image, the CPU 301 performs a modification processing for preventing misidentification of viewers on the post information accepted in S1601. It should be noted that the modification processing is, for example, as described above, a processing of compositing additional information indicating that the image is an AI-generated image with the AI-generated image. In addition, the modification processing is a processing of adding additional information indicating that the image is an AI-generated image as property information of the AI-generated image. In addition, the modification processing is a processing of adding a message indicating that an AI-generated image is included. In addition, the modification processing is a processing of excluding the AI-generated image from the post information. After that, the CPU 301 registers, in the post information database 405, the post information on which the modification processing has been performed (S1605), and the post information transmission processing of FIG. 16 ends.

In the case of being determined in S1602 that this post information does not include an image, the post information transmission processing of FIG. 16 proceeds to S1605. In addition, also in the case of being determined in S1603 that the image included in the post information is not an AI-generated image, the post information transmission processing of FIG. 16 proceeds to S1605. In S1605, the CPU 301 registers, in the post information database 405, the post information accepted in S1601 as is. After that, the post information transmission processing of FIG. 16 ends.

In the embodiment described above, in the communication apparatus 102 on which the SNS application has been installed, in the case of being determined that the image included in the accepted post information is an AI-generated image, the modification processing for preventing misidentification of viewers is performed with respect to the accepted post information. In other words, in the case that the accepted post information includes an AI-generated image, the accepted post information will not be posted at least in a state that could cause viewers to misidentify. As a result, it is possible to suppress posting of AI-generated images that cause viewers to misidentify.

It should be noted that in the post information transmission processing of FIG. 16 that has been described above, in the case of being determined in S1603 that the image included in the post information is an AI-generated image, the CPU 301 may perform the same determination processing as in S1414 described above. In the case of being determined in this determination that the generation source of this image is not the information other than images (the non-image information), that is, in the case that the generation source of this image is an image, the post information transmission processing of FIG. 16 proceeds to S1605. On the other hand, in the case of being determined in this determination that the generation source of this image is the information other than images (the non-image information), the post information transmission processing of FIG. 16 proceeds to S1604. By controlling in this way, it is possible to perform the above-described modification processing on the AI-generated image that is likely to include information that is different from the facts, while preventing the modification processing from being excessively performed on the AI-generated image that does not require modification.

It should be noted that in the present embodiment, in the case that the post information includes an AI-generated image, the configuration that restricts posting of the post information, the configuration that prohibits posting of the post information, and the configuration that performs the modification processing on the post information have been described, but the present invention is not limited to these configurations. For example, in the case that post information includes audio data generated by the generative AI, posting of the post information may be restricted, or posting of the post information may be prohibited, or a modification processing may be performed on the post information. For example, this modification processing is a processing of adding information indicating that the audio data has been generated by the generative AI as property information of the audio data, or a processing of adding, to the post information, a message indicating that the audio data generated by the generative AI is included.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-025433, filed on Feb. 22, 2024, which is hereby incorporated by reference herein in its entirety.

What is claimed is:

1. A non-transitory computer-readable storage medium storing an application program for using a service that publishes post information for causing an information processing apparatus comprising the application program to execute:
a determining step of determining whether or not an image included in accepted post information is an image generated by a generative AI; and
a restricting step of, in a case of being determined that the image included in the accepted post information is an image generated by the generative AI, restricting posting of the accepted post information.

2. The non-transitory computer-readable storage medium according to claim 1, wherein
in the restricting step, a screen for allowing a poster of the accepted post information to select whether or not to post the accepted post information is displayed on a display unit of the information processing apparatus.

3. The non-transitory computer-readable storage medium according to claim 1, wherein
in the restricting step, a screen for allowing a poster of the accepted post information to instruct cancellation of posting of the accepted post information is displayed on a display unit of the information processing apparatus.

4. A non-transitory computer-readable storage medium storing an application program of an application for using a service that publishes post information for causing an information processing apparatus comprising the application program to execute:
a determining step of determining whether or not an image included in accepted post information is an image generated by a generative AI; and
a step of, in a case of being determined that the image included in the accepted post information is an image generated by the generative AI, performing a modification processing for preventing misidentification of viewers on the accepted post information.

5. The non-transitory computer-readable storage medium according to claim 4, wherein
in the modification processing, additional information indicating that the image included in the accepted post information is an image generated by the generative AI is composited with the image included in the accepted post information.

6. The non-transitory computer-readable storage medium according to claim 4, wherein
in the modification processing, additional information indicating that the image included in the accepted post information is an image generated by the generative AI is added as property information of the image included in the accepted post information.

7. The non-transitory computer-readable storage medium according to claim 4, wherein
in the modification processing, a message indicating that an image generated by the generative AI is included is added to the accepted post information.

8. The non-transitory computer-readable storage medium according to claim 4, wherein
in the modification processing, an image generated by the generative AI is excluded from the accepted post information.

9. The non-transitory computer-readable storage medium according to claim 4, wherein
the information processing apparatus comprising the application program is caused to,
in a case of being determined that the image included in the accepted post information is an image generated by the generative AI using an input image as input, not execute the step of performing the modification processing, and
in a case of being determined that the image included in the accepted post information is an image generated by the generative AI using information other than the input image as input, execute the step of performing the modification processing.

10. The non-transitory computer-readable storage medium according to claim 1, wherein
identification information indicating having been generated by the generative AI is added to an image generated by the generative AI, and
the determining step is performed based on whether or not the identification information has been added to the image included in the accepted post information.

11. The non-transitory computer-readable storage medium according to claim 4, wherein
identification information indicating having been generated by the generative AI is added to an image generated by the generative AI, and
the determining step is performed based on whether or not the identification information has been added to the image included in the accepted post information.

12. The non-transitory computer-readable storage medium according to claim 1, wherein
the determining step is performed by using an AI that inputs the image included in the accepted post information and outputs a determination result indicating whether or not to have been generated by the generative AI.

13. The non-transitory computer-readable storage medium according to claim 4, wherein
the determining step is performed by using an AI that inputs the image included in the accepted post information and outputs a determination result indicating whether or not to have been generated by the generative AI.

14. A control method for an information processing apparatus comprising an application program for using a service that publishes post information, the control method comprising:
a step of determining whether or not an image included in accepted post information is an image generated by a generative AI; and
a step of, in a case of being determined that the image included in the accepted post information is an image generated by the generative AI, restricting posting of the accepted post information.

15. A control method for an information processing apparatus comprising an application program for using a service that publishes post information, the control method comprising:
a step of determining whether or not an image included in accepted post information is an image generated by a generative AI; and
a step of, in a case of being determined that the image included in the accepted post information is an image generated by the generative AI, performing a modification processing for preventing misidentification of viewers on the accepted post information.

16. An information processing apparatus comprising an application program for using a service that publishes post information, the information processing apparatus comprising:
at least one processor; and
a memory coupled to the processor storing instructions that, when executed by the processor, cause the processor to function as:
a determining unit that determines whether or not an image included in accepted post information is an image generated by a generative AI; and
a restricting unit that, in a case of being determined that the image included in the accepted post information is an image generated by the generative AI, restricts posting of the accepted post information.

17. An information processing apparatus comprising an application program for using a service that publishes post information, the information processing apparatus comprising:
at least one processor; and
a memory coupled to the processor storing instructions that, when executed by the processor, cause the processor to function as:
a determining unit that determines whether or not an image included in accepted post information is an image generated by a generative AI; and
a processing unit that, in a case of being determined that the image included in the accepted post information is an image generated by the generative AI, performs a modification processing for preventing misidentification of viewers on the accepted post information.
